(19) United States
(12) Patent Application Publication
(10) Pub. No.: US 2025/0232628 A1
(43) Pub. Date: Jul. 17, 2025

(54) A METHOD FOR CONTROLLING PEOPLE FLOW WITHIN A CONTROL AREA

(71) Applicant: dormakaba Schweiz AG, Rümlang (CH)

(72) Inventor: Paul Studerus, Oberweningen (CH)

(21) Appl. No.: 18/705,416

(22) PCT Filed: Oct. 27, 2022
(86) PCT No.: PCT/EP2022/080151

§ 371 Date: Apr. 26, 2024

(30) Foreign Application Priority Data
Oct. 28, 2021 (CH) CH070460/2021

(51) Int. Cl. G07C 9/27; G07C 9/10

(52) U.S. Cl. CPC G07C 9/27; G07C 9/10

(57) ABSTRACT

A method for controlling people flow within a control area using one or more UWB detection device(s) associated with the control area, comprising the steps of: executing ultra-wideband transmissions with an authentication device using one or more ultra-wideband transceiver(s) of the UWB detection device(s); determining, by the UWB detection device(s), a location of the authentication device relative to one or more checkpoint(s) within the control area by processing signal properties of the one or more ultra-wideband transmissions; identifying the authentication device; determining access rights data associated with the authentication device; and generating flow control data based on the access rights data and based on the location of the authentication device.

### FIELD OF THE INVENTION

The present invention relates to a method for controlling people flow within a control area using one or more UWB detection device(s) associated with the control area. The present invention further relates to an UWB detection device configured for carrying out the method for controlling people flow as well as A people flow control system comprising one or more UWB detection devices. Furthermore, the present invention relates to a computer program product comprising computer-executable instructions which, when executed by a processing unit of an UWB detection device, causes the UWB detection device to carry out the method for controlling people flow.

### BACKGROUND OF THE INVENTION

Entry systems have become widely used in applications in particular for access control in building facilities. Access control relates to granting, denying or limiting access to particular section(s) of a controlled area, usually by means of some level of access control by use of a barrier, such as a door, turnstile, parking gate, elevator door, or other barrier.

Various prior art systems are known for access control based on various principles using corresponding technologies. According to a first known approach, referred to as “who you are”, access control is aimed to be achieved by identifying the individuals themselves, implemented using biometric identification technologies. One particular biometric identification technology used for people flow control uses face recognition to identify individuals. While face recognition technology has its merits, it is prone to error and is therefore often unreliable. Furthermore, face recognition technology has proven to be greatly affected by face covering, being for cultural and/or hygienic reasons. Alternative particular biometric identification technology used for access flow control uses fingerprint to identify individuals. Such is however disadvantageous as fingerprint recognition is often unreliable (slow, affected by the dryness of one's skin) and is particularly disadvantageous as it requires contact with a frequently used surface (the fingerprint reader).

According to a further known approach, referred to as “what you have”, access control is based on identifying individuals using something the user possesses, referred to as a token or authentication device. Particularly advantageous are keyless entry systems due to their convenience and/or reliability. Keyless entry systems operate in that an UWB detection device executes a wireless communication with an authentication device, such as a keyless fob, a keycard or an authentication device incorporating a corresponding wireless transceiver. Once said wireless communication between the UWB detection device and the authentication device has been executed, the UWB detection device exchanges data messages with the authentication device. The authentication can be initiated either by a user, for instance by pressing a button on the authentication device to trigger transmission of authentication data to the UWB detection device, or from the UWB detection device itself which periodically transmits request signals and awaits a response message from the authentication device comprising authentication data. Upon successful authentication, i.e. verification of user credentials (e.g. by correlating authentication data received from the authentication device with a list of authorized users), the UWB detection device grants access to the user in possession of the respective authentication device, e.g. by opening said barrier. On the other hand, if the authentication fails, the UWB detection device denies access to the user in possession of the respective authentication device, e.g. by locking the barrier/by keeping the barrier locked.

For close-range applications, a radio-frequency identification (RFID) transponder (or tag) is often used, which has mostly replaced earlier magnetic stripe cards. Other current solutions use infra-red systems or radio systems to transmit an authenticating signal from an authentication device to an UWB detection device of a security control system. Close-proximity keyless systems, (i.e. between direct contact and a threshold of a few centimeters), for example RFID based systems, allow determination of a user's proximity to a barrier by appropriate placement of a reader device of the UWB detection device. However, as their name implies close-proximity keyless systems suffer from the disadvantage that they require a very close proximity of the authentication device to the UWB detection device. In order to overcome this disadvantage, mid-range keyless entry systems have been proposed, in particular based on ultra-wideband UWB communication. Ultra-wideband UWB systems are advantageous since they allow reliable mid-range communication without a user having to precisely identify the reader device. As the communicating range between an authentication device and an UWB detection device increases, the convenience and ease-of-use increases, because the authentication device does not need to be placed in very close range, such as less than one centimeter from the UWB detection device. The user no longer needing to precisely locate the UWB detection device (or its antenna) not only adds convenience but also has the potential to speed up the process, thereby increasing the throughput through a barrier.

Potentially overlapping with but not identical to access control is the field of people flow control. People flow refers to the manner in which individuals move in and around a control area, such as a building or part of a building, between and within buildings. Controlling the flow of people (also referred to as people flow control or flow control) within a control area is of great importance for reasons of safety, security, efficient use of infrastructure as well as for the comfort and well-being of the people entering, exiting or present in the control area. People flow control relates to effecting some level of control on how people move in and around the control area, including guidance and/or enforcement. In contrast to access control-whereby access is granted/denied upon identification-people flow control comprises tracking movement within the control area after granting access into the controlled area, and depending on use case, take appropriate action based on said tracking.

Various prior art systems are known aimed at controlling the flow of people using similar technologies to those employed for access control, such as biometrics or keyless systems. It shall be noted that people flow control based on an authentication device controls the people flow by means of controlling the flow of authentication device(s) associated with people.

However, known people flow control methods/systems suffer from lack of flexibility to adapt to various use cases, lack of convenience and/or lack of sufficient/efficient people flow control.

### SUMMARY OF THE INVENTION

It is an object of embodiments disclosed herein to provide an improved method for controlling people flow within a control area.

Applicant has recognized that at least one reason for the drawbacks of known methods/systems for people flow control lies in that such do not take in consideration the location of the people within the control area. Hence, it is a particular object of embodiments disclosed herein to provide a method for controlling people flow within a control area which takes into account the location of people within the control area.

According to the present invention, this object is addressed by the features of the independent claim 1. In addition, further advantageous embodiments follow from the dependent claims and the description.

According to embodiments of the present invention, the above-mentioned objects are addressed by a method for controlling people flow within a control area using one or more UWB detection device associated with the control area. In a first step, ultra-wideband transmissions are executed with an authentication device using one or more ultra-wideband transceiver(s) of the UWB detection device(s).

Thereafter, a location of the authentication device relative to one or more checkpoint(s) within the control area is determined. The checkpoint(s) are defined within the control area at locations of particular interest, such as at the border between particular section(s) of the control area. According to embodiments, checkpoint(s) are associated (e.g. 1-1) with the UWB detection device(s). In particular, the checkpoint(s) being associated with the physical location of the UWB detection device(s) within the control area, respectively with the physical location of UWB antennae of the UWB detection device(s).

The location of the authentication device within the control area is determined by processing signal properties of the one or more ultra-wideband transmissions.

According to embodiments of the present invention, the UWB detection device is configured to determine the location(s) of the authentication device(s) within the control area by processing signal properties of the ultra-wideband UWB transmissions such as propagation time, amplitude difference and/or phase difference of the ultra-wideband transmissions. Determining the location(s) of the authentication device(s) within the control area by processing signal properties of the ultra-wideband UWB transmissions is advantageous since it allows a reliable and precise localization.

Determining the location of the authentication device based on the propagation time of an ultra-wideband transmission comprises measuring the time required for a signal to travel from the ultra-wideband transceiver to an ultra-wideband communication module of the authentication device and/or the time required for a signal to travel from the authentication device to the ultra-wideband transceiver. In a particular embodiment, a time difference is used as a basis for determining the distance, as it is more secure against spoofing attacks, wherein a third party may use a radio relay device to gain unauthorized access to a location or system in a so-called “relay-attack”. Depending on the embodiment, the time difference is a “one-way time-of-flight” time difference between the ultra-wideband transceiver sending the request value and the authentication device receiving the request value, or a “round-trip time-of-flight” time difference, in which a second transmission takes place from the authentication device to the ultra-wideband transceiver either prior to, or after the first transmission of the request value. In the “one-way time-of-flight” scenario, the ultra-wideband transceiver and the authentication device need to be provided with tightly synchronized clocks for accurately determining the location. In the latter case of a “round-trip time-of-flight” calculation, there is stored, either in the authentication device or the ultra-wideband transceiver, an accurate representation of the processing time, i.e. the time it takes between the reception of an ultra-wideband transmission and the sending of a response ultra-wideband transmission, which processing time allows for accurately determining the distance. Measurement of a time required for the signal to travel from the ultra-wideband transceiver to the authentication device and back “round-trip time-of-flight” is advantageous as it does not require the precise synchronization of clock signals of the ultra-wideband transceiver and the authentication device.

Determining the location of the authentication device based on amplitude difference, comprises determining the difference in signal amplitude between the signal transmitted by the ultra-wideband transceiver and the signal received by the authentication device (or vice-versa). By taking into consideration the attenuation of the signal, the distance between the ultra-wideband transceiver and the authentication device is calculated.

Determining the location of the authentication device based on phase difference comprises detecting the difference in signal phase between the signal transmitted by the ultra-wideband transceiver and the signal received by the authentication device. By taking into consideration the change in signal phase, the distance between the ultra-wideband transceiver and the authentication device is determined. It is to be understood that for the amplitude difference and phase difference, alternatively, the signal may also be transmitted by the authentication device and received by the ultra-wideband transceiver.

Subsequent, preceding or simultaneous to localizing it, the authentication device is also identified, in particular by exchanging authentication data using the ultra-wideband transmissions between the UWB detection device(s) and the authentication device

Having determined the location of the authentication device relative to one or more checkpoint(s) and having identified the authentication device, access rights data associated with the authentication device is determined. According to a first embodiment of the present invention, access rights data is determined by a query to a data store. The data store is part of any one of the UWB detection device(s)/the people flow control system and/or communicatively connected thereto, such as a building management system.

Alternatively, or additionally, access rights data associated with the authentication device is determined by processing access rights data received from the authentication device itself, for example by means of the ultra-wideband transmissions established therewith.

Thereafter, having determined the location of the authentication device and the associated access rights data, flow control data is generated based on the access rights data and based on the location of the authentication device. The flow control data comprises indication(s) of locations, directions and/or particular sections within the control area where a user associated with the authentication device is permitted, recommended and/or denied access, presence and/or passage. For example, the indication(s) of the flow control data are generated as a sorted list of a sequence of locations, directions and/or particular sections within the control area.

The flow control data can be conveyed according to several alternative or cumulative embodiments. According to an embodiment, a human-interpretable representation of at least a part of the flow control data is generated. The human-interpretable representation comprises one or more of: a visual, audible and/or haptic representation of indication(s) of locations, directions and/or particular sections within the control area where a user associated with the authentication device is permitted, recommended and/or denied access, presence and/or passage. According to embodiments, the representation is only partially human-interpretable, in that the representation also comprises a machine-readable representation, such as a barcode. After being generated, the human-interpretable representation of at least a part of the flow control data is output to the user of the authentication device. For example, the human-interpretable representation in the form of a visual indication is output on a display of an entry/exit barrier arranged within the control area, such as displaying a number indicating an elevator to take or an identification of an assigned meeting room.

Alternatively, or additionally, at least a part the flow control data and/or the human-interpretable representation thereof is transmitted to the authentication device to be output by the authentication device, such as a display, speaker or haptic device comprised by or connected to the authentication device.

It is an object of further embodiments of the present invention to provide flow control data that is able to adapt to a current occupancy of the control area. This further object is addressed in that flow control data is generated in accordance with a presence list of authentication device(s) already present within the control area and/or within particular section(s) of the control area. The presence list is retrieved from a data store internal to or communicatively accessible by one or more of the UWB detection device(s) or the flow control system. In particular, this object is addressed by denying access to the authentication device if a number of other authentication device(s) already present within the control area and/or within particular section(s) of the control area is greater than or equal to a threshold occupancy; and by granting access to the authentication device if the number of other authentication device(s) already present within the control area and/or within particular section(s) of the control area is less than the threshold occupancy. Such embodiments are advantageous for example when a threshold occupancy is imposed due to health regulations, for ensuring comfort of occupants and/or secure evacuation in case of an emergency.

In order to keep the presence list up to date, according to further embodiments, the presence list is updated based on detecting, using one or more of the UWB detection device(s), of entry and/or exit of authentication device(s) into/out of the control area and/or particular section(s) of the control area. In particular, the presence list is updated by: detecting, using one or more of the UWB detection device(s), entry and/or exit of authentication device(s) into/out of the control area and/or particular section(s) of the control area; recording an identification of the authentication device(s) onto the presence list upon detection of entry; and by removing the identification of the authentication device from the presence list upon detection of exit. Alternatively, or additionally, the presence list is updated by incrementing the number of authentication device(s) already present upon detection of entry; and by decrementing the number of authentication device(s) already present upon detection of exit.

It is an object of further embodiments disclosed herein to enable providing flow control data which takes into account different kinds of individuals present, entering or leaving the control area or particular section(s) thereof. This object is addressed in that one or more attribute(s) associated with the authentication device are determined upon detection and identification of the authentication device. Correspondingly, the presence list (of authentication devices already present in the control area) is categorized in accordance with the one or more attributes. Furthermore, the presence list is updated upon detection of entry or exit into respectively out of the control area or particular section(s) thereof in accordance with the attributes of the authentication device(s) entering or exiting.

Depending on the particular use case, the attributes associated with authentication devices comprise indications whether the user of the authentication device is vaccinated or not, is a registered personnel of the control area or a visitor, is a maintenance staff or administrator of the control area, respectively of the people flow control system. Having determined the one or more attribute(s) associated with the authentication device upon detection and identification of the authentication device, the flow control data is generated in accordance with the categorized presence list and in accordance with the one or more attribute(s) of the authentication device. For example, personnel or administrators of a control area are provided different indication(s) than visitors. In particular, personnel or administrators may be granted access as opposed to visitors if the number of authentication device(s)—and hence people—within the control area or a section thereof-exceeds the threshold occupancy. As a further example, people possessing authentication devices associated with an attribute indicative of a valid vaccination certificate are directed—by means of flow control data—to a different section of the control area than people who lack a valid vaccination certificate.

According to further embodiments of the present invention, the flow control data generated comprises data indicative of a transit path. A transit path comprises data identifying one or more checkpoint(s) and/or one or more section(s) of the control area delimited by one or more checkpoint(s). In particular, a transit path comprises data indicative of adjoining sections of the control area and/or adjoining checkpoints that link the determined location of the authentication device to a destination area. The destination area relates to either a particular section of the control area and/or a specific checkpoint. In order to generate flow control data indicative of a transit path, a destination area associated with the authentication device is determined upon its identification. The destination area may be determined by a query to a data store (comprised by and/or communicatively connected to one or more of the UWB detection device(s) and/or the people flow control system), the data store comprising data identifying a destination area associated with the authentication device, such as its owner's office, an allocated meeting room based on a calendar/schedule associated with the owner of the authentication device. Alternatively, or additionally, data indicative the destination area is transmitted by the authentication device, in particular using the ultra-wideband transmission(s) executed with one or more of the UWB detection device(s).

Having determined the destination area, the transit path within the control area is calculated according to various parameters, the transit path T providing a virtual route within the control area between a checkpoint associated with the location of the authentication device and the checkpoint associated with the destination area D.

According to embodiments of the present invention, occupancy data within the control area is retrieved for optimizing the transit path based on the occupancy data and the destination area. Such embodiments are advantageous since for example congestions and overcrowding of particular section(s) of the control area may be avoided or at least reduced. Occupancy data is retrieved by means of a query to a data store (comprised by and/or communicatively connected to one or more of the UWB detection device(s) and/or the people flow control system). According to particular embodiments, the occupancy data comprises an indication of the occupancy level of one or more of a plurality of transport means within the control area, such as a plurality of elevators. Having available the occupancy level of one or more of a plurality of transport means within the control area, the step of optimizing the transit path based on the occupancy data and the destination area comprises determining a target transport means. Correspondingly, the flow control data comprises an indication of the target transport means plurality of transport means, such as an indication of which elevator to take based on the occupancy level of a plurality of elevators within the control area.

It is an object of further embodiments to provide flow control data that accommodates access restrictions within the control area. This object is addressed by determining access restriction(s) associated with the UWB detection device-upon its identification- and by generating the transit path such as not to violate the access restriction(s). According to a particular embodiment, the access restriction(s) comprises an indication of restricted section(s) of the control area, relative to one or more of the checkpoint(s) and/or defined by one or more checkpoint(s). Correspondingly, the transit path is determined to provide a virtual route within the control area between a checkpoint associated with the location of the authentication device and the checkpoint associated with the destination area D while avoiding restricted section(s).

According to even further embodiments, the access restriction(s) comprises an indication of restricted user interaction(s), i.e. the presence of two authentication devices within the same section(s) of the control area. Correspondingly, the transit path is determined such as not to intersect the transit path(s) associated with any of the authentication device(s) identified by the restricted user interaction(s). Alternatively, or additionally, the transit path is determined such that the transit path does not comprise section(s) of the control area where any of the authentication device(s) identified by the restricted user interaction(s) is/are located, wherein the location of authentication device(s) identified by the restricted user interaction(s) is determined by one or more of the UWB detection device(s).

It is an object of further embodiments to ensure compliance of users with the flow control data. This further object is addressed by repeatedly determining, by the UWB detection device(s), the location of the authentication device relative to one or more checkpoint(s) within the control area by processing signal properties of the one or more ultra-wideband transmissions; and by enforcing people flow within the control area. In particular, enforcing people flow within the control area comprises comparing the location of the authentication device with the flow control data and generating an alert signal indicative of a deviation of the location of the authentication device from the flow control data. The alert signal may comprise one or more of: an audible, a visual, a haptic alert and/or an electronic data alert to a system communicatively connected to the flow control system.

In order to provide an even stricter enforcement of the people flow, enforcing people flow within the control area comprises generating control signals to restrict movement of the user of the authentication device relative to checkpoint of the control area according to the flow control data. According to an embodiment, control signals are generated for the control of one or more barriers arranged within the control area, each barrier being configured to be able to physically restrict or even prevent passage of a user (and hence the authentication device carried by the user) from one section of the control area to another.

In order to enforce a transit path (of the flow control data), control signals are generated for the control of transport means within the control area. For example, control signals are generated which determine the destination floor of elevator(s) upon detection of the respective authentication device within the elevator. Correspondingly, UWB detection device(s) are arranged such as to be able to detect the presence of an authentication device within the elevator.

It is a further object of the present invention to provide an improved UWB detection device for controlling people flow within a control area. According to the present invention, this object is addressed by the features of claim 15. In particular, this object is addressed by a UWB detection device, comprising a processing unit and one or more ultra-wideband transceiver(s), the UWB detection device being configured for carrying out the method for controlling people flow within a control area according to one of the embodiments disclosed herein.

It is a further object of the present invention to provide an improved system for controlling people flow within a control area. According to the present invention, this object is addressed by the features of claim 16. In particular, this object is addressed by a people flow control system comprising a processing unit, one or more UWB detection device(s), each UWB detection device comprising one or more ultra-wideband transceiver(s), the people flow control system being configured for carrying out the method for controlling people flow within a control area according to one of the embodiments disclosed herein.

It is a further object of the present invention to provide a computer program product for improved control of people flow within a control area. According to the present invention, this object is addressed by the features of claim 17. In particular, thus object is addressed by a computer program product comprising computer-executable instructions which, when executed by a processing unit of a people flow control system comprising one or more UWB detection device(s), each UWB detection device comprising one or more ultra-wideband transceiver(s), causes the people flow control system to carry out the method according to one of the embodiments disclosed herein.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims. The drawings in which:

FIG. 1A: shows a highly schematic perspective view of a people flow control system associated with a control area according to the present invention;

FIG. 1B: shows a highly schematic perspective view of an array of checkpoints associated with the control area of FIG. 1A;

FIG. 1C: shows a highly schematic perspective view of a further embodiment of checkpoints associated with the control area of FIG. 1A;

FIG. 2: shows a highly schematic perspective view of a further embodiment of a people flow control system according to the present invention, illustrating denial of entry for the holder of an authentication device based on a number of authentication devices already present within the control area exceeding a threshold occupancy;

FIG. 3: shows a highly schematic perspective view of a further embodiment of a people flow control system according to the present invention, illustrating updating of a presence list of authentication device(s) already present within the control area upon entry and/or exit of authentication device(s) into/out of the control area;

FIG. 4: shows a highly schematic perspective view of a further embodiment of a people flow control system according to the present invention, illustrating generation of people flow control data in accordance with attributes associated with authentication devices;

FIG. 5: shows a highly schematic perspective view of a further embodiment of a people flow control system according to the present invention, illustrating generation of a transit path (as part of people flow control data) from the location of the authentication device to a destination area based on occupancy level of one or more of a plurality of transport means within the control area;

FIG. 6: shows a highly schematic perspective view of a further embodiment of a people flow control system according to the present invention, illustrating generation of a transit path (as part of people flow control data) from the location of the authentication device to a destination area based access restrictions associated with the authentication device;

FIG. 7: shows a highly schematic perspective view of a further embodiment of a people flow control system according to the present invention, illustrating generation of a transit path (as part of people flow control data) from the location of the authentication device to a destination area in a multi-story building, the transit path comprising both a pathway as well as indication of an elevator supplied with control signals to enforce the people flow by controlling a destination of the elevator according to the transit path;

FIG. 8: shows a highly schematic block diagram of a UWB detection device according to the present invention;

FIG. 9A: shows a highly schematic block diagram of a first embodiment of an authentication device according to the present invention comprised by a smartphone;

FIG. 9B: shows a highly schematic block diagram of a further embodiment of an authentication device according to the present invention comprised by a tag (such as a key tag or badge);

FIG. 10: shows a highly schematic block diagram of an embodiment of a people flow control system according to the present invention;

FIG. 11: shows a first embodiment of a method for controlling people flow within a control area according to the present invention;

FIG. 12: shows a further embodiment of a method for controlling people flow within a control area according to the present invention, comprising the generation of a human-interpretable representation of the flow control data;

FIG. 13: shows a further embodiment of a method for controlling people flow within a control area according to the present invention, wherein generation of flow control data comprises generating a transit path;

FIG. 14: shows a further embodiment of a method for controlling people flow within a control area according to the present invention, further comprising enforcement of people flow; and

FIG. 15: shows a further embodiment of a method for controlling people flow within a control area according to the present invention, further comprising generation of control signals to restrict movement within the control area.

### DETAILED DESCRIPTION OF EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

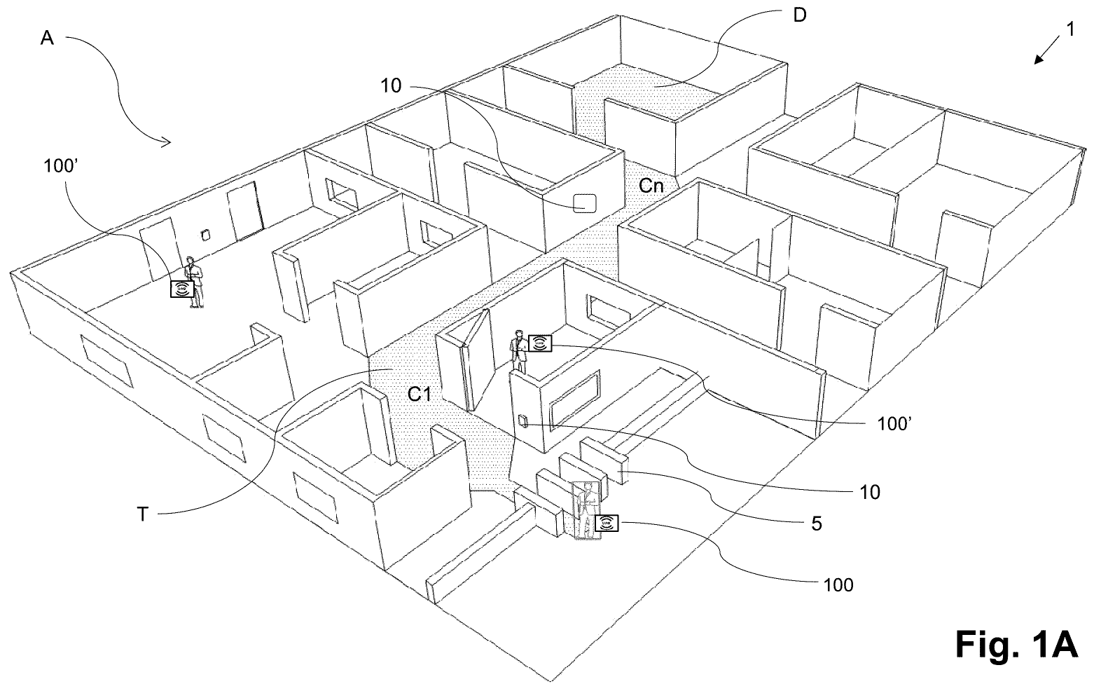

FIG. 1A shows a highly schematic perspective view of a people flow control system 1 associated with a control area A, the control area A comprising a floor of a building including an entrance area comprising a plurality of barriers 5 arranged such as to be able to restrict or even prevent passage of persons therethrough. A plurality of UWB detection devices 10 are arranged within and associated with the control area A at locations such as to enable detection of the location of authentication device 100 relative to one or more checkpoint(s) C1-n, C1.1-Cm.n within the control area A. The checkpoints c1-n, C1.1-Cm.n are defined within a control area A such as to cover at least a portion thereof. In the embodiment shown on FIG. 1B, the checkpoints C1.1.-m.n are arranged in a grid covering at least a portion of the control area A. It shall be noted that the checkpoints C1.1-Cm.n must not be co-located with the UWB detection device(s) 10. However, the placement of the UWB detection device(s) 10 is such so as to enable the plurality of UWB detection device(s) 10 to determine the location of authentication devices 100 relative to one or more checkpoints, preferably all checkpoints C1.1-Cm.n.

As shown on FIG. 1C, alternatively or additionally, the checkpoints C1-n are arranged according to areas of interest across the control area A.

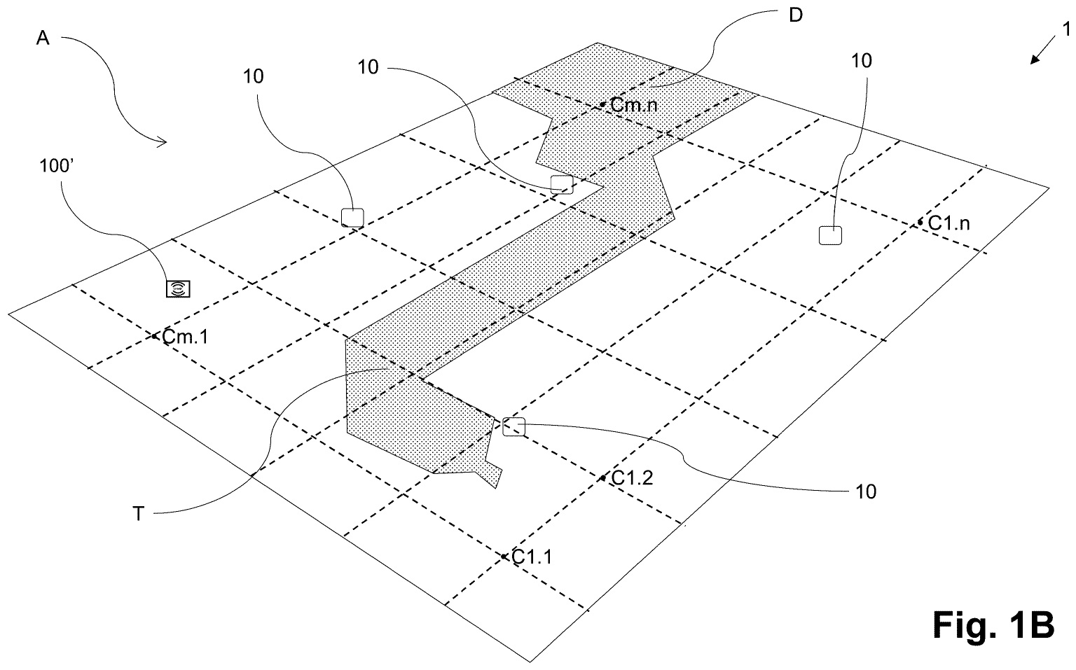

FIG. 2 shows a highly schematic perspective view of a further embodiment of a people flow control system 1 according to the present invention, illustrating denial of entry for the holder of an authentication device 100 based on a number of authentication devices 100′ already present within the control area A exceeding a threshold occupancy. The denial of entry (generation of corresponding access control data) is enforced by means of a plurality of barriers 5 arranged at an entry/exit area of the control area A.

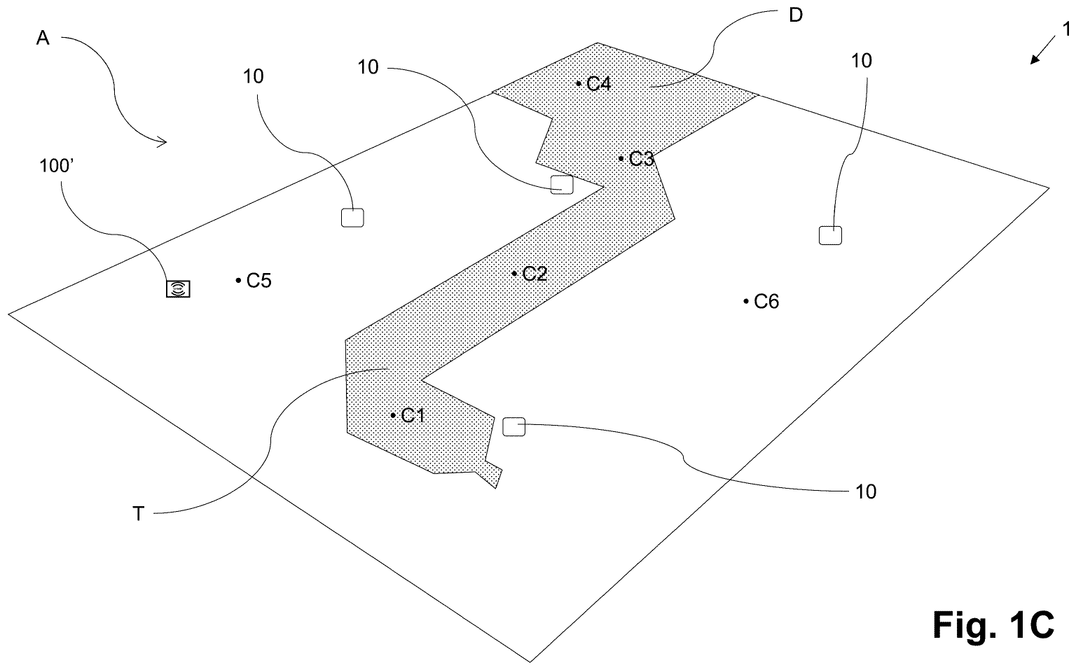

FIG. 3 shows a highly schematic perspective view of a further embodiment of a people flow control system 1 according to the present invention, illustrating updating of a presence list of authentication device(s) 100′ already present within the control area A upon entry and/or exit of authentication device(s) 100, 100′ into/out of the control area A.

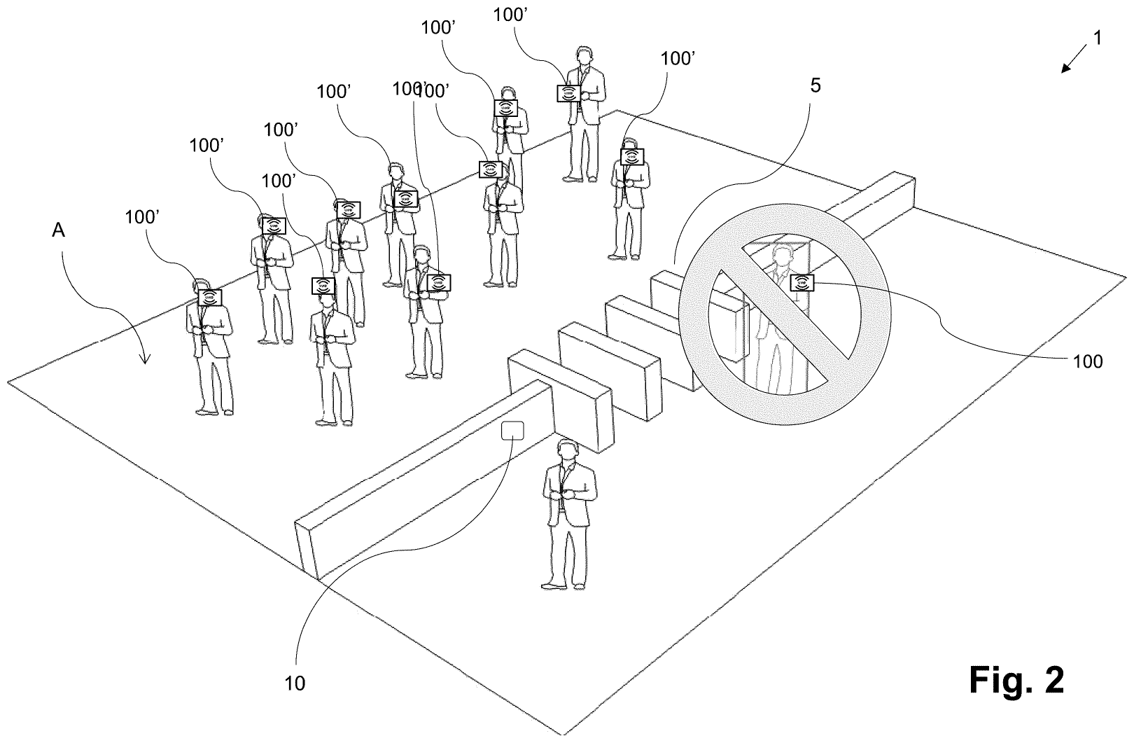

FIG. 4 shows a highly schematic perspective view of a further embodiment of a people flow control system 1 according to the present invention, illustrating generation of people flow control data in accordance with attributes associated with authentication devices 100, 100′. The one or more attribute(s) associated with the authentication device 100 are determined upon detection and identification of authentication devices 100, 100′ by any one of the plurality of UWB detection devices 10. Correspondingly, the presence list (of authentication devices 100 already present in the control area A) is categorized in accordance with the one or more attributes. Furthermore, the presence list is updated upon detection of entry or exit into respectively out of the control area or particular section(s) thereof in accordance with the attributes of the authentication device(s) entering or exiting.

Depending on the particular use case, the attributes associated with authentication devices 100, 100′ comprise indications whether the user of the authentication device is vaccinated or not, is a registered personnel of the control area A or a visitor, is a maintenance staff or administrator of the control area A, respectively of the people flow control system 1. Having determined the one or more attribute(s) associated with the authentication device 100 upon detection and identification, the flow control data is generated in accordance with the categorized presence list and in accordance with the one or more attribute(s) of the authentication device 100. As illustrated on FIG. 4 with a grey rectangle around occupant's silhouettes, authentication devices of personnel or administrators 100p of a control area A are provided different indication(s) than visitors' 100.

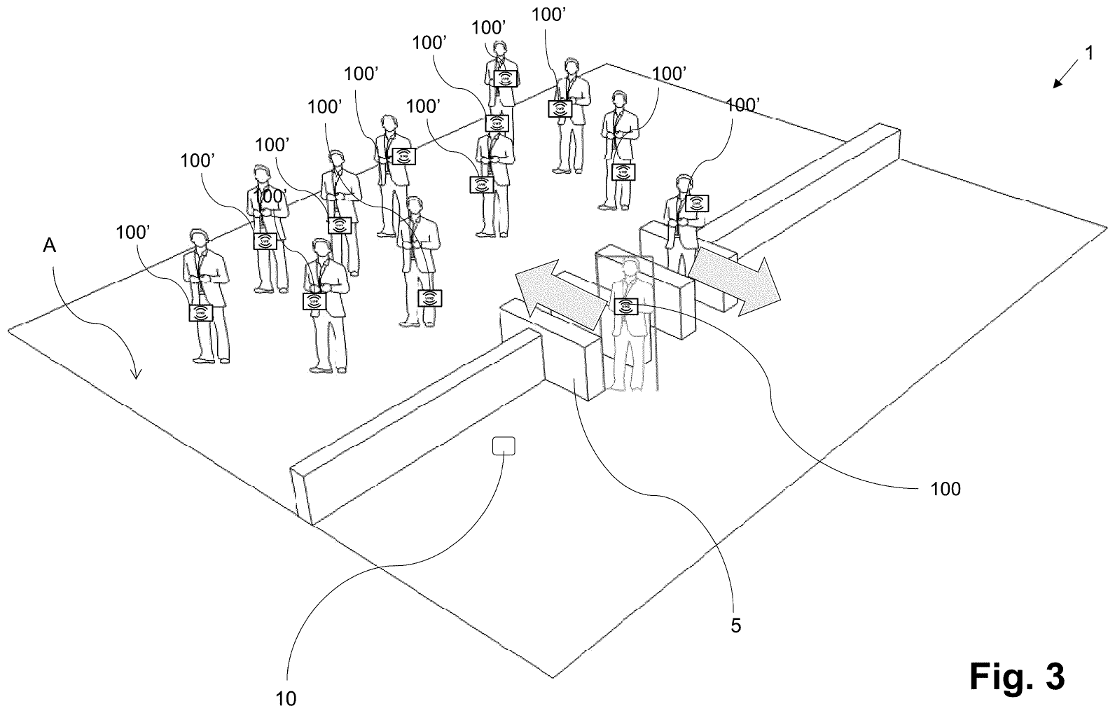

FIG. 5 shows a highly schematic perspective view of a further embodiment of a people flow control system 1 according to the present invention, illustrating generation of a transit path T (as part of people flow control data) from the location of the authentication device 100 to a destination area D. In the illustrated scenario, the destination area D is located on a floor of the building (checkpoint C6) where the first elevator (from the left) will make a stop. The transit path T comprises data identifying several more checkpoint(s) C1, C2 (the elevator) and C6 (the building floor of the destination area D), linking the location of the authentication device 100 to the destination area D. As illustrated, the transit path T has been determined based on occupancy level the plurality of elevators (transport means) within the control area A, the second, third and fourth elevators (from the left) being highly occupied.

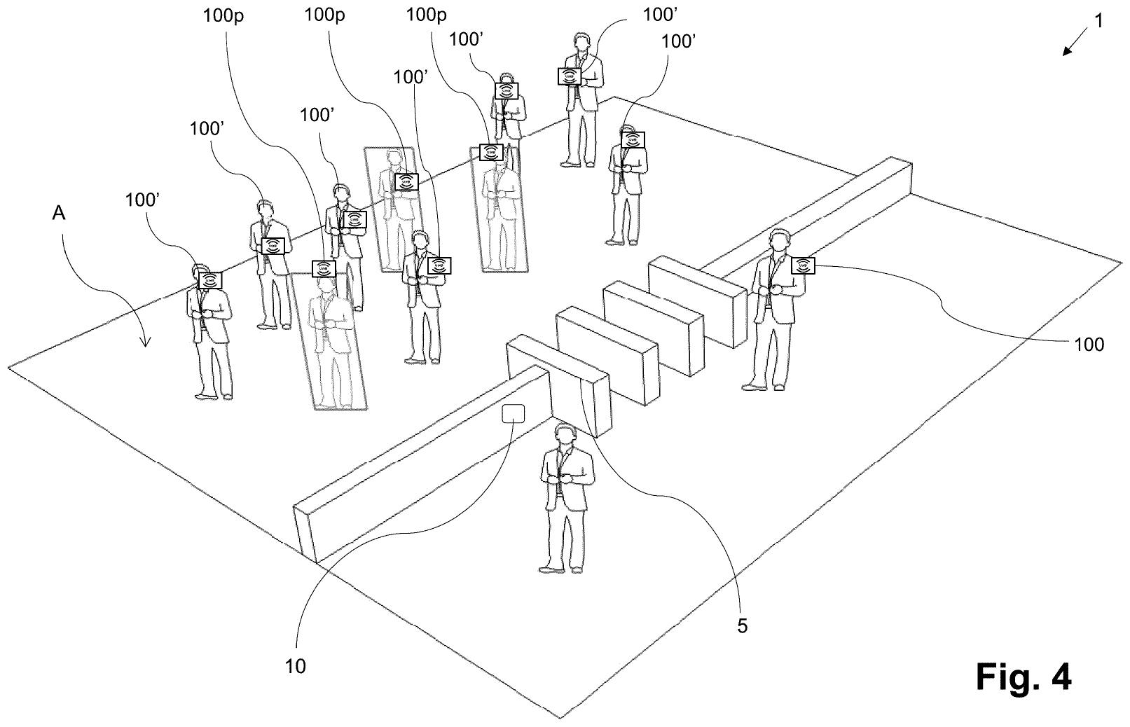

FIG. 6 shows a highly schematic perspective view of a further embodiment of a people flow control system 1 according to the present invention, illustrating a use case similar to that of FIG. 5, however in this use case, the transit path T from the location of the authentication device 100 to the destination area D is determined based access restrictions associated with the authentication device 100, namely denial to access any one of the building floors (respectively areas located on respective floors defined by checkpoints C7, C10, C11 and C12) where the second, third and fourth elevators (from the left) will make a stop.

Side note: the checkpoint labels shown on FIGS. 5 and 6 above elevator doors illustrate the checkpoints associated with building floors where the respective elevator makes a stop.

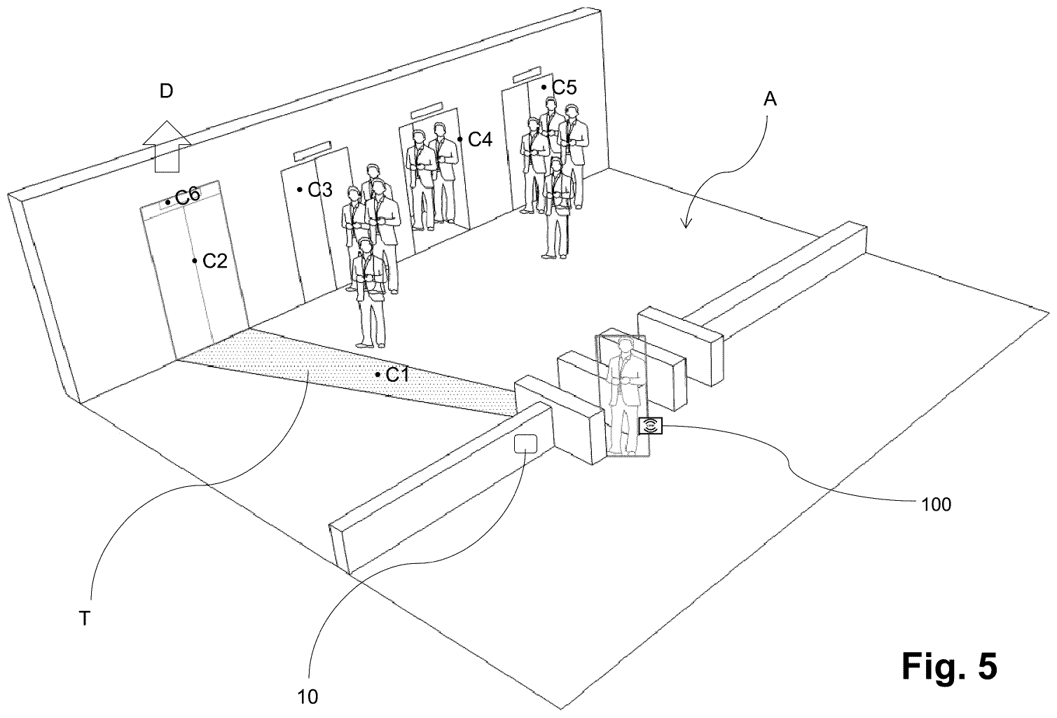

FIG. 7 shows a highly schematic perspective view of a use case of a people flow control system 1 according to the present invention, illustrating generation of a transit path T (as part of people flow control data) from the location of the authentication device 100 to a destination area D in a multi-story building. The transit path T comprises both a pathway (defined as a series of checkpoint C1.1-Cm.n) as well as indication of an elevator (by its associated checkpoint) supplied with control signals to enforce the people flow by controlling a destination of the elevator according to the transit path T. As illustrated, the transit path excludes the office on the third floor to which checkpoint C3.1 is associated with, in view of an access restriction comprising an indication of restricted user interaction(s), in particular forbidding the presence of the authentication device 100 within the same section(s) of the control area A as further authentication device 100′

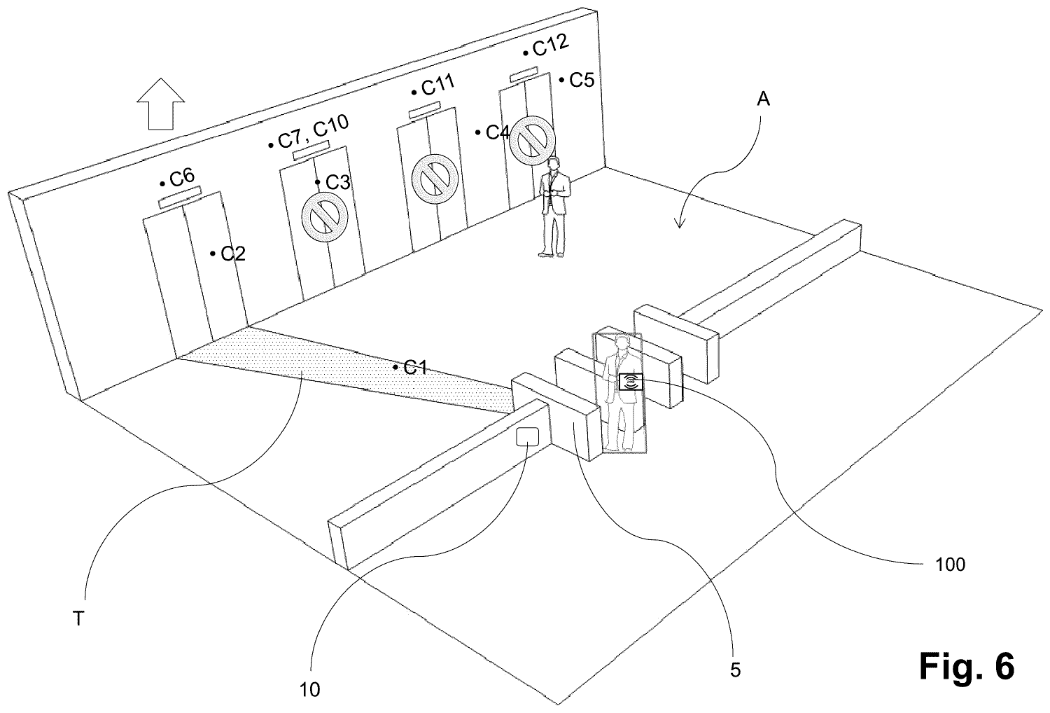

FIG. 8 shows a highly schematic block diagram of a UWB detection device 10 according to the present invention. As shown, the UWB detection device 10 comprises a processing unit 14 and one or more ultra-wideband transceiver(s) 12. The one or more ultra-wideband transceiver(s) 12 are configured to executed ultra-wideband transmissions with authentication devices 100 in order to determine their location by processing signal properties of the ultra-wideband UWB transmissions such as propagation time, amplitude difference and/or phase difference of the ultra-wideband transmissions.

The UWB detection device 10, in particular its processing unit 14 is configured for carrying out the method for controlling people flow within a control area A according to one of the embodiments disclosed herein.

According to further embodiments of the present disclosure (shown with dashed lines on FIG. 5), the UWB detection device 10 further comprises a communication module 16 for establishing data communication link(s) with other UWB detection device 10 and/or the barrier(s) 5 and/or with a processing unit 14 of the people flow control system 1 external to any one of the UWB detection devices 10. According to embodiments of the present disclosure, the communication module 16 comprises wireless communication interface(s) (such as Bluetooth Low Energy BLE, a Wireless Local Area Network WLAN, ZigBee, Radio Frequency Identification RFID, Z-Wave, and/or Near Field Communication NFC interface(s)) and/or wired communication interface(s) (such as an Ethernet interface).

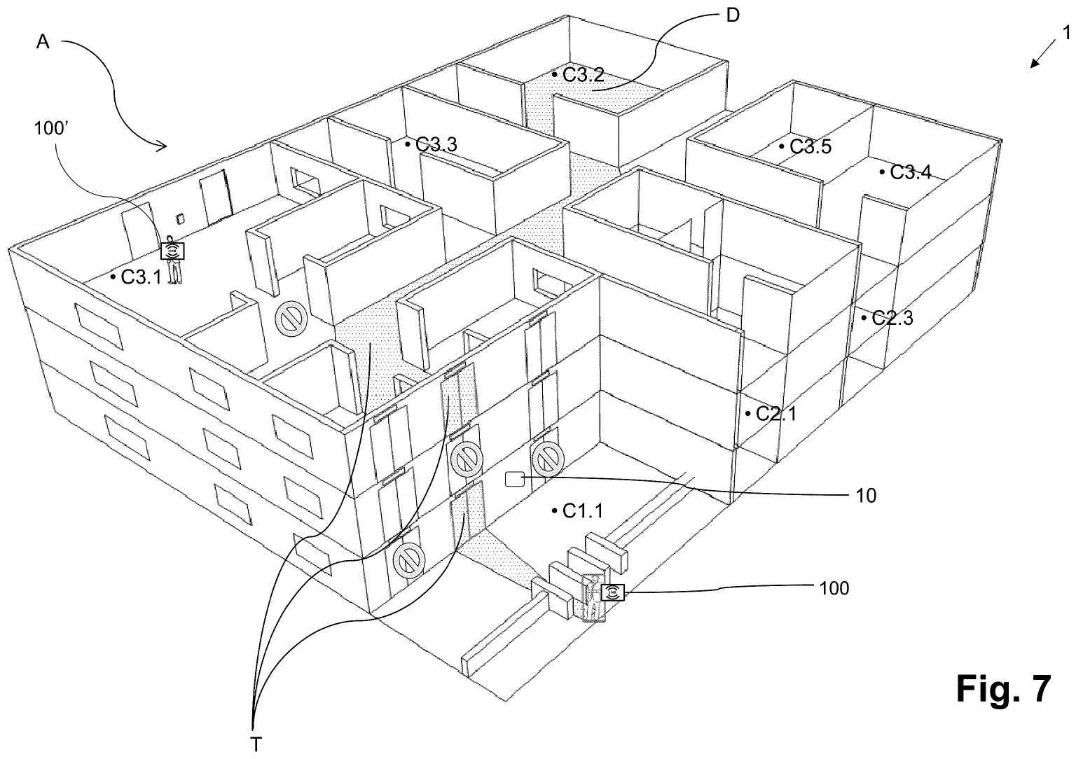

FIG. 9A shows a highly schematic block diagram of a first embodiment of an authentication device 100 according to the present invention comprised by a smartphone, the authentication device 100 comprising a display screen 104 for displaying (among other information) the visual representations of the flow control data. Furthermore, the authentication devices 100 comprise an ultra-wideband communication module 102. The ultra-wideband communication module 102 is configured for establishing an ultra-wideband transmission with the respective ultra-wideband transceiver(s) 12 of the UWB detection device(s) 10 of the security control system 1.

FIG. 9B shows a highly schematic block diagram of a further embodiment of an authentication device according to the present invention comprised by a tag (such as a key tag or badge).

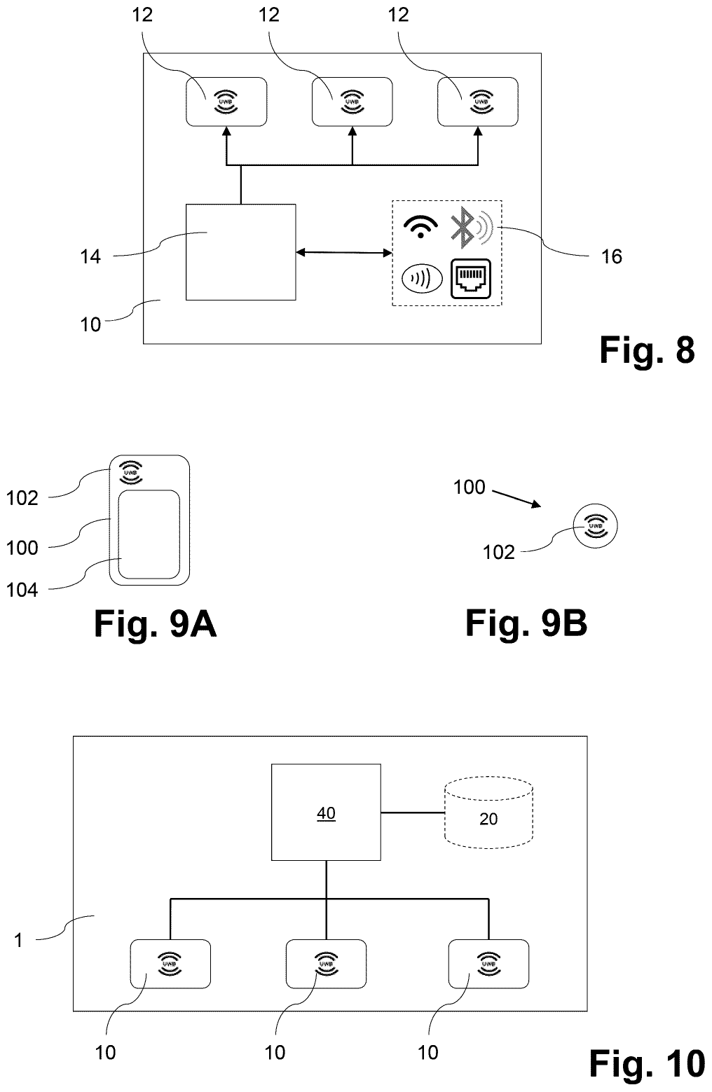

FIG. 10 shows a highly schematic block diagram of an embodiment of a people flow control system 1 according to the present invention, wherein the plurality of UWB detection devices 10 are communicatively connected to a processing unit 40 and optionally to a data store 20.

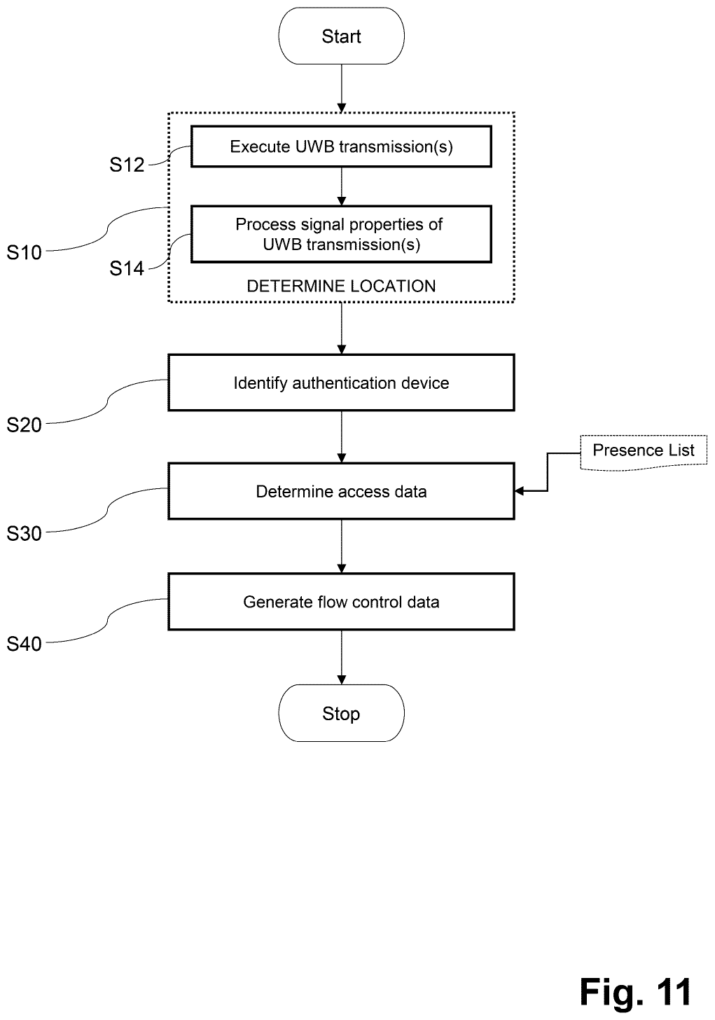

Turning now to FIGS. 11 to 15, the method for controlling people flow within a control area according to various embodiments of the present invention shall be described with reference to corresponding flowcharts.

As a preparatory step, checkpoint(s) C1-n, 1.1-n.m are defined within the control area A. Details on how the checkpoints are defined have been described in preceding paragraphs related to FIGS. 1B and 1C.

FIG. 11 shows a flowchart of a first embodiment of a method for controlling people flow within a control area A. In a first step S10, the location of the authentication device 100 relative to one or more checkpoint(s) C1-n, C1.1-Cm.n within the control area A is determined. As part of the first step S10, in a substep S12, ultra-wideband transmissions are executed with an authentication device 100 using one or more ultra-wideband transceiver(s) 12 of the UWB detection device(s) 10. Thereafter, as part of substep S14, signal properties of the one or more ultra-wideband transmissions are processed to enable determination of the location of the authentication device(s) 100.

In a step S20, subsequent, preceding or simultaneous to step S10, the authentication device 100 is identified, in particular by exchanging authentication data using the ultra-wideband transmissions between the UWB detection device(s) and the authentication device 100.

Having determined the location of the authentication device 100 relative to one or more checkpoint(s) C1-n, C1.1-Cm.n and having identified the authentication device 100, in a subsequent step S30, access rights data associated with the authentication device 100 is determined.

Thereafter, having determined the location of the authentication device and the associated access rights data, in step S40, flow control data is generated based on the access rights data and based on the location of the authentication device 100. The flow control data comprises indication(s) of locations, directions and/or particular sections within the control area A where a user associated with the authentication device 100 is permitted, recommended and/or denied access, presence and/or passage. For example, the indication(s) of the flow control data are generated as a sorted list of a sequence of locations, directions and/or particular sections within the control area A.

According to embodiments, as illustrated with dashed lines on FIG. 11, the flow control data is generated in accordance with a presence list of authentication device(s) 100′ already present within the control area A and/or within particular section(s) of the control area A. The presence list is retrieved from a data store internal to or communicatively accessible by one or more of the UWB detection device(s) 10 or the flow control system 1.

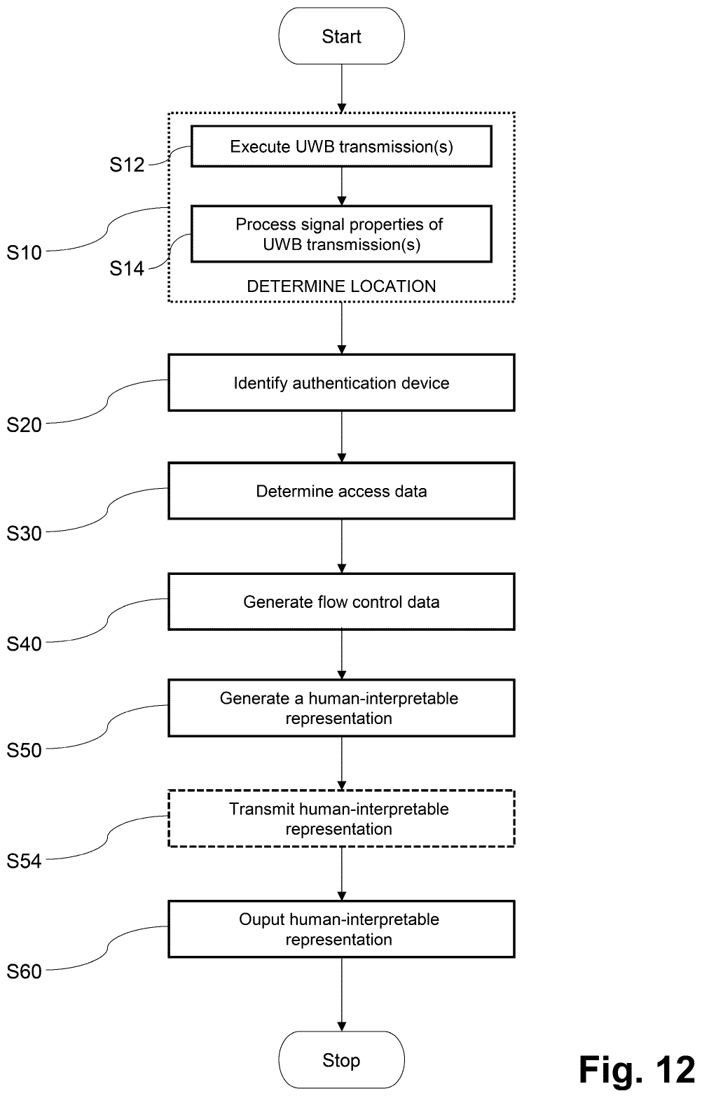

As shown on FIG. 12, according to an embodiment, a human-interpretable representation of at least a part of the flow control data is generated in step S50. The human-interpretable representation comprises one or more of: a visual, audible and/or haptic representation of indication(s) of locations, directions and/or particular sections within the control area A where a user associated with the authentication device 100 is permitted, recommended and/or denied access, presence and/or passage. After being generated, in a subsequent step S60, the human-interpretable representation of at least a part of the flow control data is output to the user of the authentication device 100. For example, the human-interpretable representation in the form of a visual indication is output on a display of an entry/exit barrier arranged within the control area, such as displaying a number indicating an elevator to take or an identification of an assigned meeting room.

Illustrated on FIG. 12 with dashed lines, according to embodiments, in a step S54 at least a part the flow control data and/or the human-interpretable representation thereof is transmitted to the authentication device 100 to be output by the authentication device 100, for example on a display, speaker or haptic device comprised by or connected to the authentication device.

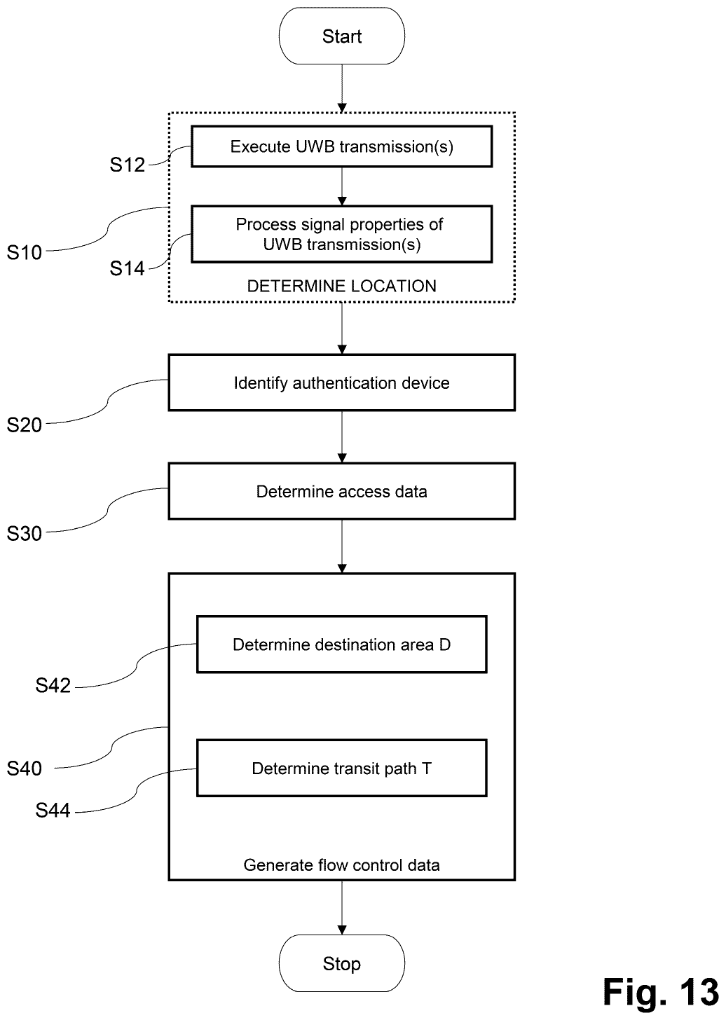

As illustrated on FIG. 13, according to a further embodiment of a method for controlling people flow within a control area A, in a step 40, a transit path T is generated. In a first substep S42, a destination area D associated with the authentication device 100 is determined upon its identification. The destination area D may be determined by a query to a data store 20 (comprised by and/or communicatively connected to one or more of the UWB detection device(s) 10 and/or the people flow control system 1, the data store 20 comprising data identifying a destination area A associated with the authentication device 100, such as its owner's office, an allocated meeting room based on a calendar/schedule associated with the owner of the authentication device. Alternatively, or additionally, data indicative the destination area D is transmitted by the authentication device 100, in particular using the ultra-wideband transmission(s) executed with one or more of the UWB detection device(s) 10. Thereafter, in substep S44, a transit path T is determined by the processing unit 14 or 40, comprising data indicative of checkpoints C1-n, 1.1-n.m that link the location of the authentication device 100—as determined in step S10—to its destination area D.

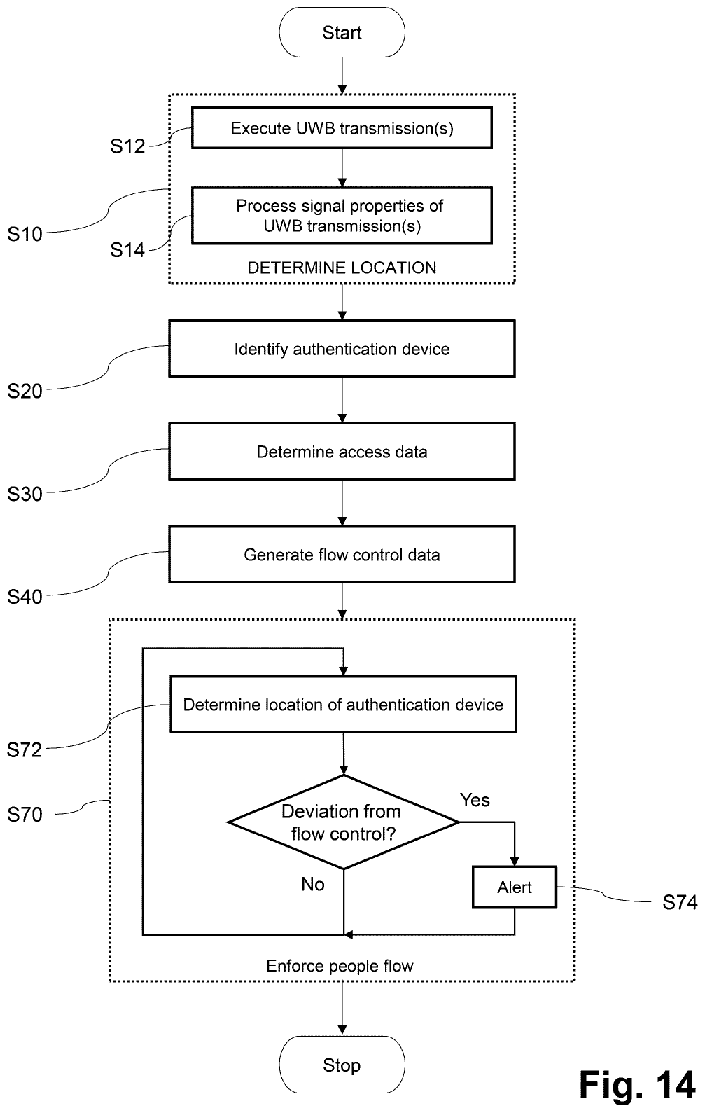

FIG. 14: shows a further embodiment of a method for controlling people flow within a control area A according to the present invention, further comprising enforcement of people flow in step S70. As part of step S70, in a substep S72 the location of the authentication device 100 relative to one or more checkpoint(s) C1-n, C1.1-Cm.n within the control area A is repeatedly determined by processing signal properties of the one or more ultra-wideband transmissions. Thereafter, the location of the authentication device 100 is compared with the flow control data. According to step S74 an alert signal is generated, the alert signal being indicative of a deviation of the location of the authentication device 100 from the flow control data.

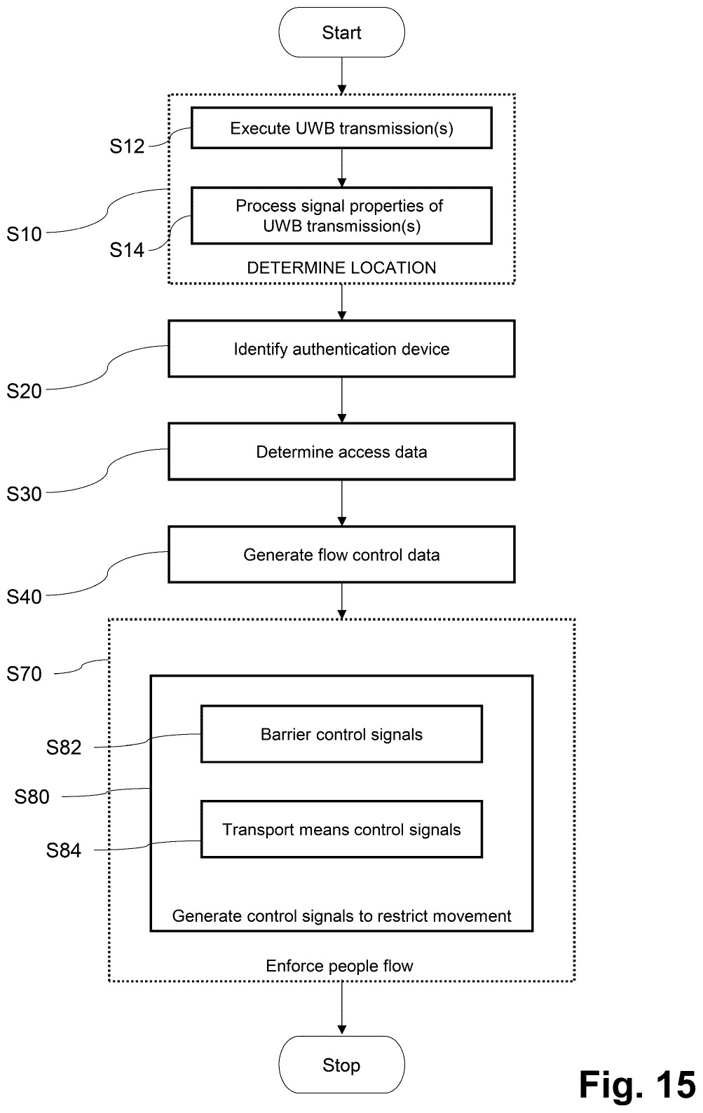

As shown on FIG. 15, in order to provide an even stricter enforcement of the people flow, in a step S80 control signals are generated to restrict movement of the user of the authentication device 100 between sections of the control area A according to the flow control data. According to a step S82, control signals are generated for the control of one or more barriers 5 arranged within the control area A, each barrier 5 being configured to be able to physically restrict or even prevent passage of a user (and hence the authentication device carried by the user) from one section of the control area to another (as defined by respective checkpoints C1-n, 1.1-n.m).

Alternatively, or additionally, in order to enforce a transit path T (of the flow control data), according to step S84, control signals are generated for the control of transport means within the control area A. For example, control signals are generated which determine the destination floor of elevator(s).

List of reference numerals

| | |
|---|---|
| people flow control system | 1 |
| barrier | 5 |
| UWB detection device | 10 |
| ultra-wideband transceiver | 12 |
| processing unit (of UWB detection device) | 14 |
| processing unit (of people flow control system) | 40 |
| communication module | 16 |
| data store | 20 |
| authentication device | 100, 100′ |
| ultra-wideband communication module | 102 |
| (of the authentication device) | |
| display (of authentication device) | 104 |
| control area | A |
| transit path | T |
| destination area | D |
| checkpoint | C1-n, |
| | C1.1-Cm.n |

1. A method for controlling people flow within a control area using one or more UWB detection device(s) associated with the control area, comprising the steps of:
executing ultra-wideband transmissions with an authentication device using one or more ultra-wideband transceiver(s) of the UWB detection device(s);
determining, by the UWB detection device(s), a location of the authentication device relative to one or more checkpoint(s) within the control area by processing signal properties of the one or more ultra-wideband transmissions;
identifying the authentication device;
determining access rights data associated with the authentication device;
generating flow control data based on the access rights data and based on the location of the authentication device in accordance with a presence list of authentication device(s) already present within the control area and/or within particular section(s) of the control area.

2. The method according to claim 1, further comprising:
generating an at least partially human-interpretable representation of at least a part of the flow control data; and
outputting the at least partially human-interpretable representation to the user of the authentication device.

3. The method according to claim 1 or 2, further comprising transmitting at least a part the flow control data to the authentication device to be output by the authentication device.

4. (canceled)

5. The method according to any one of claims 1 to 3, further comprising updating the presence list based on detecting, using one or more of the UWB detection device(s), entry and/or exit of authentication device(s) into/out of the control area and/or particular section(s) of the control area.

6. The method according to any one of claims 1 to 4, further comprising:
determining one or more attribute(s) associated with the authentication device;
categorizing the presence list in accordance with the one or more attribute(s); and
generating flow control data in accordance with the presence list and in accordance with the one or more attribute(s) of the authentication device.

7. The method according to one of the claims 1 to 6, further comprising:
determining a destination area associated with the authentication device;
determining a transit path from the location of the authentication device to the destination area;
wherein flow control data comprises data indicative of the transit path.

8. The method according to claim 7, further comprising:
retrieving occupancy data within the control area; and
optimizing the transit path based on the occupancy data and the destination area.

9. The method according to claim 8, wherein:
the occupancy data comprises an indication of the occupancy level of one or more of a plurality of transport means within the control area,
optimizing the transit path based on the occupancy data and the destination area comprises determining a target transport means; and
the flow control data comprises an indication of the target transport means plurality of transport means.

10. The method according to one of the claims 7 to 9, further comprising determining access restriction(s) associated with the UWB detection device, wherein the transit path is generated such as not to violate the access restriction(s).

11. The method according to claim 10, wherein the access restriction(s) comprises:
an indication of restricted section(s) of the control area, wherein the transit path is determined such as to avoid restricted section(s); and/or
an indication of restricted user interaction(s), wherein the transit path is determined such as not to intersect the transit path(s) associated with any of the authentication device(s) identified by the restricted user interaction(s) and/or such that the transit path does not comprise section(s) of the control area where any of the authentication device(s) identified by the restricted user interaction(s) is/are located.

12. The method according to one of the claims 1 to 11, further comprising:
repeatedly determining, by the UWB detection device(s), the location of the authentication device relative to one or more checkpoint(s) within the control area by processing signal properties of the one or more ultra-wideband transmissions; and
enforcing people flow within the control area.

13. The method according to claim 12, wherein enforcing people flow within the control area comprises comparing the location of the authentication device with the flow control data and generating an alert signal indicative of a deviation of the location of the authentication device from the flow control data.

14. The method according to claim 12 or 13, wherein enforcing people flow within the control area comprises generating control signals to restrict movement of a user of the authentication device between sections of the control area according to the flow control data, comprising:
control signals for the control of one or more barriers arranged within the control area; and/or
control signals for the control of transport means within the control area.

15. An UWB detection device, comprising a processing unit and one or more ultra-wideband transceiver(s), the UWB detection device being configured for carrying out the method according to one of the claims 1 to 14.

16. A people flow control system for controlling people flow within a control area, comprising a processing unit and one or more UWB detection device(s), each UWB detection device comprising one or more ultra-wideband transceiver(s).

17. A computer program product comprising computer-executable instructions which, when executed by a processing unit of a people flow control system comprising one or more UWB detection device(s), each UWB detection device comprising one or more ultra-wideband transceiver(s), causes the people flow control system to carry out the method according to one of the claims 1 to 14.
